(19) United States
(12) Patent Application Publication
(10) Pub. No.: US 2019/0036134 A1
(43) Pub. Date: Jan. 31, 2019

(54) SYSTEM AND METHOD FOR PREPARING HIGH-ACTIVITY SPECIFIC-VALENCE-STATE ELECTROLYTE OF ALL-VANADIUM FLOW BATTERY

(71) Applicants: INSTITUTE OF PROCESS ENGINEERING, CHINESE ACADEMY OF SCIENCES, Beijing (CN); BEIJING ZHONGKAIHONGDE TECHNOLOGY CO., LTD, Beijing (CN)

(72) Inventors: Qingshan ZHU, Beijing (CN); Haitao YANG, Beijing (CN); Chuanlin FAN, Beijing (CN); Wenheng MU, Beijing (CN); Jibin LIU, Beijing (CN); Cunhu WANG, Beijing (CN); Qixun BAN, Beijing (CN)

(73) Assignees: INSTITUTE OF PROCESS ENGINEERING, CHINESE ACADEMY OF SCIENCES, Beijing (CN); BEIJING ZHONGKAIHONGDE TECHNOLOGY CO., LTD, Beijing (CN)

(21) Appl. No.: 16/073,846

(22) PCT Filed: Jan. 16, 2017
(86) PCT No.: PCT/CN2017/071203

§ 371 Date: Jul. 30, 2018

(30) Foreign Application Priority Data
Jan. 28, 2016 (CN) 201610059741.6

(51) Int. Cl. H01M 8/04186; H01M 8/18

(52) U.S. Cl. CPC H01M 8/04186; H01M 2300/0011; H01M 8/188

(57) ABSTRACT

A system and method for preparing a high-activity specific-valence electrolyte of an all-vanadium redox flow battery. A vanadium-containing material is reduced into a low-valence vanadium oxide with an average valence in the range of 3.0-4.5 through precise control of fluidization, then water and sulfuric acid are added for dissolution, and microwave field is further adopted for activation, so as to obtain a specific-valence vanadium electrolyte. Efficient utilization of heat is achieved through heat exchange between the vanadium-containing material and reduction tail gas and heat exchange between the reduction product and fluidized nitrogen gas. An internal member and feed outlets at different heights are arranged in a reduction fluidized bed to achieve precise control over the valence state of the reduction product, and the special chemical effect of the microwave field is used to activate the vanadium ions, thereby improving the activity of the electrolyte greatly.

### CROSS REFERENCE TO RELATED APPLICATIONS

This application is based upon and claims priority to PCT Application Number PCT/CN2017/071203, filed on Jan. 16, 2017, which stems from Chinese Application Number 201610059741.6 filed on Jan. 28, 2016, both of which are incorporated herein by reference in their entirety.

### TECHNICAL FIELD

The present invention relates to the fields of energy and chemical engineering, and more particularly to a system and method for preparing a high-activity specific-valence electrolyte of an all-vanadium redox flow battery.

### BACKGROUND

Traditional fossil fuels have always been the main source of energy, however, long-term exploitation and heavy use results in depletion of resources and also brings about serious environmental pollution. The development and utilization of clean renewable energy sources such as wind, water, solar, and tidal energies have gradually attracted the attention of human society. However, renewable energy sources are difficult to be effectively used by the existing energy management systems due to their inherent intermittence.

Energy storage technology is one of ways to solve such problems. In various kinds of energy storage systems, the all-vanadium redox flow battery (VRB) is an attractive energy storage device. The biggest advantage of VRB is its flexibility—power and energy storage capacity are independent. The power of VRB depends on the number of battery cells and the effective electrode area of battery cells, while the energy storage capacity depends on the concentration of the active material in the electrolyte and the volume of the electrolyte. Each battery cell consists of two electrode chambers (positive and negative electrode chambers) separated by a proton exchange membrane. The electrolyte, that is the sulfate solution of vanadium, is used to store energy. When the electrolyte flows through the battery cell, redox reactions of V(IV)/V(V) and V(II)/V(III) occur in the positive and negative electrode chambers, respectively.

The methods for preparing the VRB electrolyte are as follows: (1) VOSO₄ method: U.S. Pat. No. 849,094 discloses a mixed vanadium electrolyte with a concentration ratio of V(III) to V(I) of 1:1, which is prepared by dissolving VOSO₄ in a sulfuric acid solution, and then adjusting the valence state electrochemically. The main problem of this method lies in the more complicated preparation process of VOSO₄ and high price, which is not conducive to the large-scale application in VRB. (2) Chemical reduction method: Chinese patent CN101562256 discloses a mixed vanadium electrolyte of V(III) and V(IV), which is prepared by adding a reducing agent such as oxalic acid, butyraldehyde, etc. to the mixed system of V₂O₅ and a sulfuric acid solution, and keeping the mixture at 50-100 CC, for 0.5-10 hours for chemical reduction. The main problem of the method lies in that it is not easy to control the degree of reduction, and addition of the reducing agent will introduce a new impurity into the vanadium electrolyte system. (3) Electrolytic method: International PCT patent AKU88/000471 describes a mixed vanadium electrolyte with a concentration ratio of V(III) to V(IV) of 1:1, which is prepared by adding the activated V₂O₅ to a sulfuric acid solution, and then performing constant current electrolysis. Preparation of the vanadium electrolyte by the electrolytic method is suitable for large-scale production of the electrolyte, but the process requires a preliminary activating treatment, which needs an additional electrolysis device and consumes electrical energy. (4) Method by dissolving a low-valence vanadium oxide: Chinese patent CN101728560A. discloses that the high-purity V₂O₃ is used as a raw material and dissolved in 1:1 dilute sulfuric acid at a temperature of 80-150° C. to prepare a solution of V₂(SO₄)₃ used as a negative electrode electrolyte. The process is operated at a temperature of 80-150° C. (at which temperature the V(III) vanadium ion hydrate is prone to form an oxygen-bridge bond, leading to the production of polycondensation and thus a decreased electrolyte activity), and lacks an activation step. This method can only be used to prepare a negative electrode electrolyte with a narrow application area. Chinese patent CN102468509A discloses a method for preparing a vanadium battery electrolyte, which comprises: preparing V₂O₃ by segmented calcination at 200-300° C. and 600-700° C. with ammonium metavanadate and ammonium bicarbonate as raw materials, dissolving V₂O₃ in a dilute sulfuric acid and reacting for 5-20 hours at 50-120° C. to obtain a V₂(SO₄)₃ solution, and dissolving V₂O₅ in the V₂(SO₄)₃ solution and reacting for 1-3 hours at 80-110° C. to obtain a vanadium battery electrolyte with an average vanadium ion valence of 3.5. The V₂(SO₄)₃ solution is prepared as the negative electrode electrolyte in this patent. The method also has the problems of long-time dissolution operation at a higher temperature (at which temperature the V(III) vanadium ion hydrate is prone to form an oxygen-bridge bond, leading to the production of polycondensation and thus a decreased electrolyte activity), and lack of an activation step. Chinese patent CN103401010A discloses a method for preparing an all-vanadium redox flow battery electrolyte, which comprises: reducing V₂O₅ powder in hydrogen gas to prepare V₂O₄ powder and V₂O₃ powder, dissolving V₂O₄ and V₂O₃ in the concentrated sulfuric acid respectively to obtain the positive and negative electrode electrolytes of the vanadium battery. The main problem of the patent lies in that no specific reduction process is provided, The V₂O₄ powder is prepared by reducing V₂O₅ in hydrogen gas, however, in the process, over-reduction or under-reduction is prone to occur and the process only can be achieved by precise control, but the patent does not provide measures about the precise control of reduction. Chinese patents CN101880059A and CN102557134A disclose a fluidized reduction furnace and reduction method for producing high-purity vanadium trioxide, wherein a heat transfer internal member is added in a fluidized bed to achieve the enhanced heat transfer; and cyclone preheating is used to increase the energy utilization rate and realize the efficient preparation of V₂O₃. However, since the systems do not have the function of precise control of reduction, the methods described in these two patents are only suitable for the preparation of V₂O₃ and not suitable for the preparation of other low-valence vanadium oxides.

In summary, there is an urgent need in the art to solve the disadvantages of the process and technology for preparation of the all-vanadium redox flow battery electrolyte, so as to provide a system and method for preparing a VRB electrolyte simply and quickly, with low cost, short process, controllable valence state and high activity.

### SUMMARY

In view of the above problems, the present invention proposes a system and method for preparing a high-activity specific-valence electrolyte of an all-vanadium redox flow battery, to implement the preparation of a VIM electrolyte simply and quickly, with low cost, short process, controllable valence state and high activity. In order to achieve these objectives, the present invention adopts the following technical solutions.

The present invention provides a system for preparing a high-activity specific-valence electrolyte of an all-vanadium redox flow battery, comprising a vanadium-containing material feeding device 1, a vanadium-containing material preheating device 2, a reduction fluidized bed device 3, a low-valence vanadium oxide pre-cooling device 4, a low-valence vanadium oxide secondary cooling device 5, a low-valence vanadium oxide feeding device 6, a dissolution reactor 7, and an electrolyte activation device 8;

wherein the vanadium-containing material feeding device 1 comprises a vanadium-containing material hopper 1-1 and a vanadium-containing material screw feeder 1-2;

the vanadium-containing material preheating device 2 comprises a venturi preheater 2-1, a cyclone preheater 2-2 and a first cyclone separator 2-3;

the reduction fluidized bed 3 comprises a vanadium-containing material feeder 3-1, a. reduction fluidized bed body 3-2, a reduction fluidized bed cyclone separator 3-3, a reduction fluidized bed discharger 3-4, a reduction fluidized bed preheater 3-5, and a reducing gas purifier 3-6;

the low-valence vanadium oxide pre-cooling device 4 comprises a venturi cooler 4-1, a cyclone cooler 4-2, and a second cyclone separator 4-3;

the low-valence vanadium oxide feeding device 6 comprises a. low-valence vanadium oxide hopper 6-1 and a low-valence vanadium oxide screw feeder 6-2;

wherein a feed outlet at the bottom of the vanadium-containing material hopper 1-1 is connected with a feed inlet of the vanadium-containing material screw feeder 1-2; and a feed outlet of the vanadium-containing material screw feeder 1-2 is connected with a feed inlet of the venturi preheater 2-1 through a pipeline;

a gas inlet of the venturi preheater 2-1 is connected with a gas outlet of the reduction fluidized bed cyclone separator 3-3 through a pipeline; a feed outlet of the venturi preheater 2-1 is connected with a feed inlet of the cyclone preheater 2-2 through a pipeline; a feed outlet of the cyclone preheater 2-2 is connected with a feed inlet of the vanadium-containing material feeder 3-1 through a pipeline; a gas outlet of the cyclone preheater 2-2 is connected with a gas inlet of the first cyclone separator 2-3 through a pipeline; a gas outlet of the first cyclone separator 2-3 is connected with a tail gas treatment system through a pipeline; and a feed outlet of the first cyclone separator 2-3 is connected with the feed inlet of the vanadium-containing material feeder 3-1 through a pipeline;

a feed outlet of the vanadium-containing material feeder 3-1 is connected with a feed inlet of the reduction fluidized bed 3-2 through a pipeline; an aeration air inlet of the vanadium-containing material feeder 3-1 is connected with a nitrogen gas main pipe through a pipeline; a gas outlet of the reduction fluidized bed 3-2 is connected with a gas inlet of the reduction fluidized bed cyclone separator 3-3 through a pipeline; a feed outlet of the reduction fluidized bed cyclone separator 3-3 is connected with a feed inlet of the reduction fluidized bed discharger 3-4 through a pipeline; a feed outlet of the reduction fluidized bed 3-2 is connected with the feed inlet of the reduction fluidized bed discharger 3-4 through a pipeline; a feed outlet of the reduction fluidized bed discharger 3-4 is connected with a feed inlet of the venturi cooler 4-1 through a pipeline; an aeration air inlet of the reduction fluidized bed discharger 3-4 is connected with a purified nitrogen gas main pipe through a pipeline; a reducing gas inlet of the reduction fluidized bed 3-2 is connected with a gas outlet of the reducing gas preheater 3-5 through a pipeline; a gas inlet of the reducing gas preheater is connected with a gas outlet of the second cyclone separator 4-3 through a pipeline; a gas inlet of the reducing gas preheater is connected with a gas outlet of the reducing gas purifier 3-6 through a pipeline; a gas inlet of the reducing gas purifier 3-6 is connected with a reducing gas main pipe through a pipeline; and an air inlet and a fuel inlet of the reducing gas preheater 3-5 are connected with a compressed air main pipe and a fuel main pipe, respectively;

a gas inlet of the venturi cooler 4-1 is connected with the purified nitrogen gas main pipe through a pipeline; a feed outlet of the venturi cooler 4-1 is connected with a feed inlet of the cyclone cooler 4-2 through a pipeline; a feed outlet of the cyclone cooler 4-2 is connected with a feed inlet of the low-valence vanadium oxide secondary cooling system 5 through a pipeline; a gas outlet of the cyclone cooler 4-2 is connected with a gas inlet of the second cyclone separator 4-3 through a pipeline; and a feed outlet of the second cyclone separator 4-3 is connected with a feed inlet of the low-valence vanadium oxide secondary cooling device 5 through a pipeline;

a feed outlet of the low-valence vanadium oxide secondary cooling device 5 is connected with a feed inlet of the low-valence vanadium oxide hopper 6-1 through a pipeline; a cooling water inlet of the low-valence vanadium oxide secondary cooling device 5 is connected with a process water main pipe through a pipeline; and a cooling water outlet of the low-valence vanadium oxide secondary cooling device 5 is connected with a water cooling system through a pipeline;

a feed outlet at the bottom of the low-valence vanadium oxide hopper 6-1 is connected with a feed inlet of the low-valence vanadium oxide screw feeder 6-2; and a feed outlet of the low-valence vanadium oxide screw feeder 6-2 is connected with a feed inlet of the dissolution reactor 7 through a pipeline;

a clean water inlet of the dissolution reactor 7 is connected with a clean water main pipe through a pipeline; a concentrated sulfuric acid inlet of the dissolution reactor 7 is connected with a concentrated sulfuric acid main pipe through a pipeline; a gas outlet of the dissolution reactor 7 is connected with a gas inlet of the tail gas treatment system through a pipeline; and an electrolyte outlet of the dissolution reactor 7 is connected with an electrolyte inlet of the electrolyte activation device 8 through a pipeline,

The present invention further provides a method for preparing a high-activity specific-valence electrolyte of an all-vanadium redox flow battery based on the above system, which comprises the following steps:

allowing vanadium-containing material from the vanadium-containing material hopper 1-1 to enter the venturi preheater 2-1, the cyclone preheater 2-2 and the first cyclone separator 2-3 in turn through the vanadium-containing material screw feeder 1-2, and then enter the reduction fluidized bed body 3-2 through the vanadium-containing material feeder 3-1; allowing the powder entrained in the high-temperature tail gas discharged from the reduction fluidized bed body 3-2 to be collected by the reduction fluidized bed cyclone separator 3-3 and then enter the feed inlet of the reduction fluidized bed discharger 3-4; making the reduced low-valence vanadium oxide be discharged from a feed outlet of the reduction fluidized bed body 3-2, and enter the venturi cooler 4-1 and the cyclone cooler 4-2 in turn through the reduction fluidized bed discharger 3-4, and enter the low-valence vanadium oxide secondary cooling device 5 and the low-valence vanadium oxide hopper 6-1 together with the powder material recovered by the second cyclone separator 4-3; allowing the material to enter the dissolution reactor 7 through the low-valence vanadium oxide screw feeder 6-2, and be subjected to dissolution reaction together with clean water from the clean water main pipe and concentrated sulfuric acid from the concentrated sulfuric acid main pipe to obtain a primary electrolyte; and allowing the primary electrolyte in the dissolution reactor 7 to enter the electrolyte activation device 8 through a pipeline with a valve, and be activated to obtain the high-activity specific-valence electrolyte of an all-vanadium redox flow battery;

wherein purified nitrogen gas enters the venturi cooler 4-1, the cyclone cooler 4-2 and the second cyclone separator 4-3 in turn, and is mixed with the reducing gas purified by the reducing gas purifier 3-6 and preheated by the reduction fluidized bed preheater 3-5, and then enters the reduction fluidized bed body 3-2, such that the vanadium-containing material powder is kept at a fluidized state and reduced; the high-temperature tail gas after reduction enters the reduction fluidized bed cyclone separator 3-3, the venturi preheater 2-1 and the cyclone preheater 2-2 in turn, and finally is subjected to dust removing by the first cyclone separator 2-3 and then transmitted to the tail gas treatment system; and nitrogen gas from other two pipelines originating from the purified nitrogen gas main pipe enters the vanadium-containing material feeder 3-1 and the reduction fluidized bed discharger 3-4, respectively;

wherein compressed air and fuel enter a compressed air inlet and the fuel inlet of the reduction fluidized bed preheater 3-5, respectively;

wherein process water from the process water main pipe flows into a water inlet of the low-valence vanadium oxide secondary cooling device 5 and flows out of a water outlet of the low-valence vanadium oxide secondary cooling device 5, and then enters the water cooling system.

The first characteristic of the present invention lies in that: the reduction fluidized bed body 3-2 is in the form of a rectangular multi-bin double outlet structure, and the fluidized bed has a built-in vertical baffle, each feed outlet is provided with a plug-in valve, and two feed outlets at high and low positions are respectively connected with the feed inlet of the reduction fluidized bed discharger 3-4 through pipelines.

The second characteristic of the present invention lies in that: the vanadium-containing material is one or more of vanadium pentoxide, ammonium metavanadate and ammonium polyvanadate.

The third characteristic of the present invention lies in that: the reducing gas introduced into the reducing gas purifier 3-6 is a mixture of one or two selected from hydrogen gas, ammonia gas, electric furnace gas, converter gas, blast furnace gas, coke oven gas and gas producer gas.

The fourth characteristic of the present invention lies in that: by controlling the operation temperature, the average residence time of the powder, and the reducing atmosphere in the reduction fluidized bed, the average vanadium valence of the low-valence vanadium oxide in the reduction product can be any value in the range of 3.0-4.5;

wherein the operation temperature in the reduction fluidized bed is 400-700° C., in order to achieve this temperature, the corresponding temperature of the reduction fluidized bed preheater 3-5 is controlled to be 450-950° C.;

the average residence time of the powder is 30-60 minutes, wherein when the average vanadium valence of the target low-valence vanadium oxide is 3.0-3.6, a feed outlet at a high position is used for discharging; and when the average vanadium valence of the target low-valence vanadium oxide is 3.6-4.5, a feed outlet at a low position is used for discharging;

the controlling and the reducing atmosphere has a volume fraction of the reducing gas in the mixed gas of nitrogen gas and the ratio of the reducing gas to the mixed gas of nitrogen is 10%-90%.

The fifth characteristic of the present invention lies in that: in the high-activity specific-valence electrolyte of the all-vanadium redox flow battery prepared in the dissolution reactor 7, the average valence of vanadium ions is any value in the range of 3.0-4.5, the concentration of vanadium ions is in the range of 1.0-3.0 mol/L, and the concentration of sulfuric acid is in the range of 3.0-6.0 mol/L; particularly, when the average valence of vanadium ions in the electrolyte is 3.5, the electrolyte can be directly used for a new all-vanadium redox flow battery stack.

The sixth characteristic of the present invention lies in that: in the electrolyte activation device 8, the electrolyte is activated by applying microwave field externally with the activation time of 30-300 minutes, the activation temperature of 20-85° C., the microwave power density of 10-300 W/L, and the microwave frequency of 2450 MHz or 916 MHz.

The process for preparing an electrolyte in the present invention is of low cost, short process, controllable valence state, high activity, convenient transportation, and simple and quick. The present invention has the following outstanding advantages over the prior art:

(1) Realizing the sensible heat utilization of the high-temperature tail gas and high-temperature reduction product in the fluidized bed: the high-temperature tail gas discharged from the reduction fluidized bed is in direct contact with the cold vanadium-containing material, such that the cold vanadium-containing material is heated while the sensible heat of the high-temperature reduction tail gas is recovered; the purified nitrogen gas for reduction is in direct contact with the discharged high-temperature low-valence vanadium oxide product, such that the purified nitrogen gas is preheated while the reduction product is cooled to recover the sensible heat of the high-temperature reduction product.

(2) Achieving the open circulation of ultrafine powder: the tail gas from the reduction fluidized bed is passed through an external cyclone separator, and the recovered powder enters the reduction fluidized bed discharger, thereby realizing the open circulation of the fine powder particles and avoiding the closed circulation of the fine powder particles.

(3) Adjustable valence state: the fluidized bed structure of rectangular multi-bin double outlet is used to achieve the precise control of reduction, such that a low-valence vanadium oxide having an average vanadium valence of any value in the range of 3.0-4.5 can be prepared, accordingly, an electrolyte having an average vanadium valence of any value in the range of 3.0-4.5 can be prepared; in particular, when the average valence of vanadium ions in the electrolyte is 3.5, the electrolyte can be directly used for the assembly of a new vanadium battery stack,

(4) High activity: the microwave field applied externally is used to activate the electrolyte and promote the dissociation of the oxygen-bridge bond, and the equipment is simple and convenient to implement with good activation effect,

(5) Simple preparation and convenient transportation: the process for producing the electrolyte is short, with simple preparation, and is suitable for on-site configuration of vanadium batteries; in addition, the low-valence vanadium oxide can be transported, thereby greatly reducing the transportation cost.

The present invention has the advantages of strong raw material adaptability, adequate fluidized reduction reaction, no polluted wastewater discharge, low energy consumption in production and low operation cost, stable product quality and so on, and is suitable for the large-scale industrial production of the all-vanadium redox flow battery electrolyte with different valence state requirements and high activity, thereby achieving good economic and social benefits.

### BRIEF DESCRIPTION OF THE DRAWINGS

The accompanying drawing is used to provide further illustration of the present invention and constitutes a part of the specification. It is used to explain the present invention together with the examples of the present invention, rather than limit the present invention.

FIG. 1 is a schematic diagram illustrating the configuration of a system for preparing a high-activity specific-valence electrolyte of an all-vanadium redox flow battery according to the present invention.

### DETAILED DESCRIPTION OF THE EMBODIMENTS

In order to make the object, technical solution, and advantages of the present invention be clearer, the technical solution in the examples of the present invention will be described clearly and completely below with reference to the accompanying drawing of the present invention. Obviously, the described examples are only a part of the examples of the present invention, not all examples. It is worth noting that the examples are merely used for illustrating the technical solution of the present invention, rather than limiting the present invention.

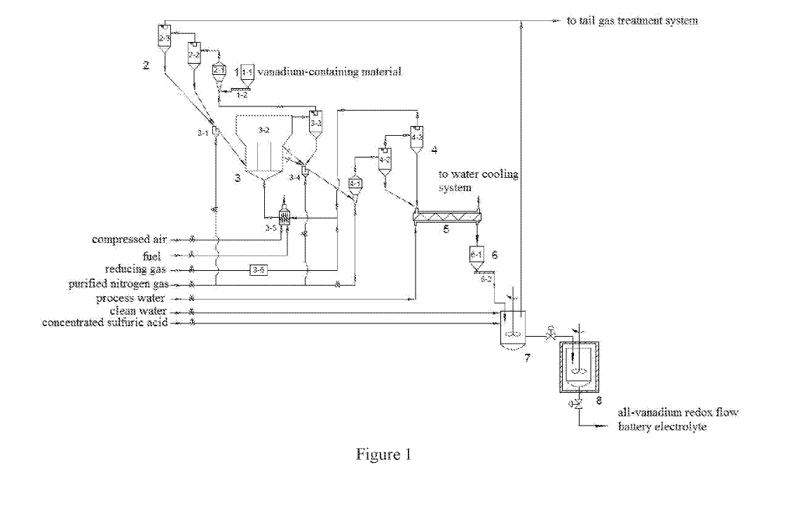

FIG. 1 includes the following designators:

1 Vanadium-containing material feeding device

1-1 Vanadium-containing material hopper

1-2 Vanadium-containing material screw feeder

2 Vanadium-containing material preheating device

2-1 Venturi preheater

2-2 Cyclone preheater

2-3 First cyclone separator

3 Reduction fluidized bed

3-1 Vanadium-containing material feeder

3-2 Reduction fluidized bed body

3-3 Reduction fluidized bed cyclone separator

3-4 Reduction fluidized bed discharger

3-5 Reduction fluidized bed preheater

3-6 Reducing gas purifier

4 Low-valence vanadium oxide pre-cooling device

4-1 Venturi cooler

4-2 Cyclone cooler

4-3 Second cyclone separator

5 Low-valence vanadium oxide secondary cooling device

6 Low-valence vanadium oxide feeding device

6-1 Low-valence vanadium oxide hopper

6-2 Low-valence vanadium oxide screw feeder

7 Dissolution reactor

8 Electrolyte activation device

### Example 1

Referring to FIG. 1, the system for preparing a high-activity specific-valence electrolyte of an all-vanadium redox flow battery used in this example comprises a vanadium-containing material feeding device 1, a vanadium-containing material preheating device 2, a reduction fluidized bed device 3, a low-valence vanadium oxide pre-cooling device 4, a low-valence vanadium oxide secondary cooling device 5, a low-valence vanadium oxide feeding device 6, a. dissolution reactor 7, and an electrolyte activation device 8.

The vanadium-containing material feeding device 1 comprises a vanadium-containing material hopper 1-1 and a vanadium-containing material screw feeder 1-2.

The vanadium-containing material preheating device 2 comprises a venturi preheater 2-1, a cyclone preheater 2-2 and a first cyclone separator 2-3.

The reduction fluidized bed 3 comprises a vanadium-containing material feeder 3-1, a reduction fluidized bed body 3-2, a reduction fluidized bed cyclone separator 3-3, a reduction fluidized bed discharger 3-4, a reduction fluidized bed preheater 3-5, and a reducing gas purifier 3-6.

The low-valence vanadium oxide pre-cooling device 4 comprises a venturi cooler 4-1, a cyclone cooler 4-2, and a second cyclone separator 4-3.

The low-valence vanadium oxide feeding device 6 comprises a low-valence vanadium oxide hopper 6-1 and a low-valence vanadium oxide screw feeder 6-2.

A feed outlet at the bottom of the vanadium-containing material hopper 1-1 is connected with a feed inlet of the vanadium-containing material screw feeder 1-2; and a feed outlet of the vanadium-containing material screw feeder 1-2 is connected with a feed inlet of the venturi preheater 2-1 through a pipeline.

A gas inlet of the venturi preheater 2-1 is connected with a gas outlet of the reduction fluidized bed cyclone separator 3-3 through a pipeline; a feed outlet of the venturi preheater 2-1 is connected with a feed inlet of the cyclone preheater 2-2 through a pipeline; a feed outlet of the cyclone preheater 2-2 is connected with a feed inlet of the vanadium-containing material feeder 3-1 through a pipeline; a gas outlet of the cyclone preheater 2-2 is connected with a gas inlet of the first cyclone separator 2-3 through a pipeline; a gas outlet of the first cyclone separator 2-3 is connected with a tail gas treatment system through a pipeline; and a feed outlet of the first cyclone separator 2-3 is connected with the feed inlet of the vanadium-containing material feeder 3-1 through a pipeline.

A feed outlet of the vanadium-containing material feeder 3-1 is connected with a feed inlet of the reduction fluidized bed 3-2 through a pipeline; an aeration air inlet of the vanadium-containing material feeder 3-1 is connected with a nitrogen gas main pipe through a pipeline; a gas outlet of the reduction fluidized bed 3-2 is connected with a gas inlet of the reduction fluidized bed cyclone separator 3-3 through a pipeline; a feed outlet of the reduction fluidized bed cyclone separator 3-3 is connected with a feed inlet of the reduction fluidized bed discharger 3-4 through a pipeline; a feed outlet of the reduction fluidized bed 3-2 is connected with the feed inlet of the reduction fluidized bed discharger 3-4 through a pipeline; a feed outlet of the reduction fluidized bed discharger 3-4 is connected with a feed inlet of the venturi cooler 4-1 through a pipeline; an aeration air inlet of the reduction fluidized bed discharger 3-4 is connected with a purified nitrogen gas main pipe through a pipeline; a reducing gas inlet of the reduction fluidized bed 3-2 is connected with a gas outlet of the reducing gas preheater 3-5 through a pipeline; a gas inlet of the reducing gas preheater is connected with a gas outlet of the second cyclone separator 4-3 through a pipeline; a gas inlet of the reducing gas preheater is connected with a gas outlet of the reducing gas purifier 3-6 through a pipeline; a gas inlet of the reducing gas purifier 3-6 is connected with a reducing gas main pipe through a pipeline; and an air inlet and a fuel inlet of the reducing gas preheater 3-5 are connected with a compressed air main pipe and a fuel main pipe, respectively.

A gas inlet of the venturi cooler 4-1 is connected with the purified nitrogen gas main pipe through a pipeline; a feed outlet of the venturi cooler 4-1 is connected with a feed inlet of the cyclone cooler 4-2 through a pipeline; a feed outlet of the cyclone cooler 4-2 is connected with a feed inlet of the low-valence vanadium oxide secondary cooling system 5 through a pipeline; a gas outlet of the cyclone cooler 4-2 is connected with a gas inlet of the second cyclone separator 4-3 through a pipeline; and a feed outlet of the second cyclone separator 4-3 is connected with a feed inlet of the low-valence vanadium oxide secondary cooling device 5 through a pipeline.

A feed outlet of the low-valence vanadium oxide secondary cooling device 5 is connected with a feed inlet of the low-valence vanadium oxide hopper 6-1 through a pipeline; a cooling water inlet of the low-valence vanadium oxide secondary cooling device 5 is connected with a process water main pipe through a pipeline; and a cooling water outlet of the low-valence vanadium oxide secondary cooling device 5 is connected with a water cooling system through a pipeline.

A feed outlet at the bottom of the low-valence vanadium oxide hopper 6-1 is connected with a feed inlet of the low-valence vanadium oxide screw feeder 6-2; and a feed outlet of the low-valence vanadium oxide screw feeder 6-2 is connected with a feed inlet of the dissolution reactor 7 through a pipeline.

A clean water inlet of the dissolution reactor 7 is connected with a clean water main pipe through a pipeline; a concentrated sulfuric acid inlet of the dissolution reactor 7 is connected with a concentrated sulfuric acid main pipe through a pipeline; a gas outlet of the dissolution reactor 7 is connected with a gas inlet of the tail gas treatment system through a pipeline; and an electrolyte outlet of the dissolution reactor 7 is connected with an electrolyte inlet of the electrolyte activation device 8 through a pipeline.

### Example 2

The system described in Example 1 is used to prepare a high-activity specific-valence electrolyte of an all-vanadium redox flow battery. The method comprises the following steps.

Vanadium-containing material from the vanadium-containing material hopper 1-1 enters the venturi preheater 2-1., the cyclone preheater 2-2 and the first cyclone separator 2-3 in turn through the vanadium-containing material screw feeder 1-2, and then enters the reduction fluidized bed body 3-2 through the vanadium-containing material feeder 3-1. The powder entrained in the high-temperature tail gas discharged from the reduction fluidized bed body 3-2. is collected by the reduction fluidized bed cyclone separator 3-3 and then enters the feed inlet of the reduction fluidized bed discharger 3-4. The reduced low-valence vanadium oxide is discharged from a feed outlet of the reduction fluidized bed body 3-2, and enters the venturi cooler 4-1 and the cyclone cooler 4-2 in turn through the reduction fluidized bed discharger 3-4, and enters the low-valence vanadium oxide secondary cooling device 5 and the low-valence vanadium oxide hopper 6-1 together with the powder material recovered by the second cyclone separator 4-3. The material enters the dissolution reactor 7 through the low-valence vanadium oxide screw feeder 6-2, and is subjected to dissolution reaction together with clean water from the clean water main pipe and concentrated sulfuric acid from the concentrated sulfuric acid main pipe to obtain a primary electrolyte. The primary electrolyte in the dissolution reactor 7 enters the electrolyte activation device 8 through a pipeline with a valve, and is activated to obtain the high-activity specific-valence electrolyte of an all-vanadium redox flow battery.

Purified nitrogen gas enters the venturi cooler 4-1, the cyclone cooler 4-2 and the second cyclone separator 4-3 in turn, and is mixed with the reducing gas purified by the reducing gas purifier 3-6 and preheated by the reduction fluidized bed preheater 3-5, and then enters the reduction fluidized bed body 3-2, such that the vanadium-containing material powder is kept at a fluidized state and reduced. The high-temperature tail gas after reduction enters the reduction fluidized bed cyclone separator 3-3, the venturi preheater 2-1 and the cyclone preheater 2-2 in turn, and finally is subjected to dust removing by the first cyclone separator 2-3 and then transmitted to the tail gas treatment system. Nitrogen gas from other two pipelines originating from the purified nitrogen gas main pipe enters the vanadium-containing material feeder 3-1 and the reduction fluidized bed discharger 3-4, respectively.

Compressed air and fuel enter a compressed air inlet and the fuel inlet of the reduction fluidized bed preheater 3-5, respectively.

Process water from the process water main pipe flows into a water inlet of the low-valence vanadium oxide secondary cooling device 5 and flows out of a water outlet of the low-valence vanadium oxide secondary cooling device 5, and then enters the water cooling system.

### Example 3

In this example, ammonium polyvanadate was used as a raw material, and the throughput was 300 kg/h. The reducing gas introduced into the reduction fluidized bed body 3-2 was coal gas from a gas producer, the volume fraction of coal gas in the mixed gas of the nitrogen gas and coal gas introduced into the reduction fluidized bed body 3-2 was 90%, the average residence time of the powder was 60 min, the low-valence vanadium oxide was discharged from the feed outlet at a high position, and the operation temperature in the reduction fluidized bed was 700 and a low-valence vanadium oxide having an average vanadium valence of 3.0 was obtained. Concentrated sulfuric acid and clean water were added to the dissolution reactor 7 to obtain a primary electrolyte.

In the activation device 8, the primary electrolyte was activated for 300 minutes at a temperature of 20° C., with a microwave power density of 10 W/L and a microwave frequency of 916 MHz, to obtain a high-activity specific-valence electrolyte of an all-vanadium redox flow battery with the average vanadium ion valence of 3.0, the concentration of vanadium ions of 1.5 mol/L and the concentration of sulfate of 5.0 mol/L.

### Example 4

In this example, ammonium metavanadate was used as a raw material, and the throughput was 30 kg/h. The reducing gas introduced into the reduction fluidized bed body 3-2 was blast furnace gas, the volume fraction of coal gas in the mixed gas of the nitrogen gas and coal gas introduced into the reduction fluidized bed body 3-2 was 10%, the average residence time of the powder was 60 min, the low-valence vanadium oxide was discharged from the feed outlet at a low position, and the operation temperature in the reduction fluidized bed was 400° C., and a low-valence vanadium oxide having an average vanadium valence of 4.5 was obtained. Concentrated sulfuric acid and clean water were added to the dissolution reactor 7 to obtain a primary electrolyte. In the activation device 8, the primary electrolyte was activated for 10 minutes at a temperature of 85° C., with a microwave power density of 300 W/L and a microwave frequency of 2450 MHz, to obtain a high-activity specific-valence electrolyte of an all-vanadium redox flow battery with the average vanadium ion valence of 4.5, the concentration of vanadium ions of 1.5 mol/L and the concentration of sulfate of 5.0 mol/L.

### Example 5

In this example, vanadium pentoxide (with a purity of above 99.996%) was used as a raw material, and the throughput was 100 kg/h. The reducing gas introduced into the reduction fluidized bed body 3-2. was hydrogen gas, the volume fraction of hydrogen gas in the mixed gas of the nitrogen gas and hydrogen gas introduced into the reduction fluidized bed body 3-2 was 50%, the average residence time of the powder was 45 min, the low-valence vanadium oxide was discharged from the feed outlet at a high position, and the operation temperature in the reduction fluidized bed was 500° C., and a low-valence vanadium oxide having an average vanadium valence of 3.5 was obtained. Concentrated sulfuric acid and clean water were added to the dissolution reactor 7 to obtain a primary electrolyte. In the activation device 8, the primary electrolyte was activated for 120 minutes at a temperature of 40° C., with a microwave power density of 200 W/L and a microwave frequency of 916 MHz, to obtain a high-activity specific-valence electrolyte of an all-vanadium redox flow battery with the average vanadium ion valence of 3.5, the concentration of vanadium ions of 1.7 mol/L, and the concentration of sulfate of 5.0 mol/L, which can be directly used for the preparation of the electrolyte of a new all-vanadium redox flow battery stack.

### Example 6

In this example, vanadium pentoxide (with a purity of above 99.996%) was used as a raw material, and the throughput was 100 kg/h. The reducing gas introduced into the reduction fluidized bed body 3-2 was hydrogen gas, the volume fraction of ammonia gas in the mixed gas of the nitrogen gas and ammonia gas introduced into the reduction fluidized bed body 3-2 was 60%, the average residence time of the powder was 30 min, the low-valence vanadium oxide was discharged from the feed outlet at a high position, and the operation temperature in the reduction fluidized bed was 600° C., and a low-valence vanadium oxide having an average vanadium valence of 3.6 was obtained. Concentrated sulfuric acid and clean water were added to the dissolution reactor 7 to obtain a primary electrolyte. In the activation device 8, the primary electrolyte was activated for 200 minutes at a temperature of 50° C., with a microwave power density of 200 W/L and a microwave frequency of 916 MHz, to obtain a high-activity specific-valence electrolyte of an all-vanadium redox flow battery with the average vanadium ion valence of 3.6, the concentration of vanadium ions of 1.7 mol/L and the concentration of sulfate of 5.0 mol/L, which can be directly used for the preparation of the electrolyte of a new all-vanadium redox flow battery stack.

The contents which are not illustrated in detail in the present invention belong to the well-known technologies in the art.

Of course, the present invention can also provide a variety of examples. According to the disclosure of the present invention, those skilled in the art can make various corresponding changes and transformations without departing from the spirit and essence of the present invention. However, these corresponding changes and transformations shall all fall within the protection scope of the claims of the present invention.

What is claimed is what is claimed is:

1. A system for preparing a high-activity specific-valence electrolyte of an all-vanadium redox flow battery, comprising a vanadium-containing material feeding device, a vanadium-containing material preheating device, a reduction fluidized bed device, a low-valence vanadium oxide pre-cooling device, a low-valence vanadium oxide secondary cooling device, a low-valence vanadium oxide feeding device, a dissolution reactor, and an electrolyte activation device;
wherein the vanadium-containing material feeding device comprises a vanadium-containing material hopper and a vanadium-containing material screw feeder;
the vanadium-containing material preheating device comprises a venturi preheater, a cyclone preheater and a first cyclone separator;
the reduction fluidized bed comprises a vanadium-containing material feeder, a reduction fluidized bed body, a reduction fluidized bed cyclone separator, a reduction fluidized bed discharger, a reduction fluidized bed preheater, and a reducing gas purifier;
the low-valence vanadium oxide pre-cooling device comprises a venturi cooler, a cyclone cooler, and a second cyclone separator;
the low-valence vanadium oxide feeding device comprises a low-valence vanadium oxide hopper and a low-valence vanadium oxide screw feeder;
wherein a feed outlet at the bottom of the vanadium-containing material hopper is connected with a feed inlet of the vanadium-containing material screw feeder ; and a feed outlet of the vanadium-containing material screw feeder is connected with a feed inlet of the venturi preheater through a pipeline;
a gas inlet of the venturi preheater is connected with a gas outlet of the reduction fluidized bed cyclone separator through a pipeline; a feed outlet of the venturi preheater is connected with a feed inlet of the cyclone preheater through a pipeline; a feed outlet of the cyclone preheater is connected with a feed inlet of the vanadium-containing material feeder through a pipeline; a gas outlet of the cyclone preheater is connected with a gas inlet of the first cyclone separator through a pipeline; a gas outlet of the first cyclone separator is connected with a tail gas treatment system through a pipeline; and a feed outlet of the first cyclone separator is connected with the feed inlet of the vanadium-containing material feeder through a pipeline;
a feed outlet of the vanadium-containing material feeder is connected with a feed inlet of the reduction fluidized bed body through a pipeline; an aeration air inlet of the vanadium-containing material feeder is connected with a nitrogen gas main pipe through a pipeline; a gas outlet of the reduction fluidized bed body is connected with a gas inlet of the reduction fluidized bed cyclone separator through a pipeline; a feed outlet of the reduction fluidized bed cyclone separator is connected with a feed inlet of the reduction fluidized bed discharger through a pipeline; a feed outlet of the reduction fluidized bed body is connected with the feed inlet of the reduction fluidized bed discharger through a pipeline; a feed outlet of the reduction fluidized bed discharger is connected with a feed inlet of the venturi cooler through a pipeline; an aeration air inlet of the reduction fluidized bed discharger is connected with a purified nitrogen gas main pipe through a pipeline; a reducing gas inlet of the reduction fluidized bed body is connected with a gas outlet of the reduction fluidized bed preheater through a pipeline; a gas inlet of the reduction fluidized bed preheater connected with a gas outlet of the second cyclone separator through a pipeline; a gas inlet of the reduction fluidized bed preheater is connected with a gas outlet of the reducing gas purifier through a pipeline; a gas inlet of the reducing gas purifier is connected with a reducing gas main pipe through a pipeline; and an air inlet and a fuel inlet of the reduction fluidized bed preheater are connected with a compressed air main pipe and a fuel main pipe, respectively;
a gas inlet of the venturi cooler is connected with the purified nitrogen gas main pipe through a pipeline; a feed outlet of the venturi cooler is connected with a feed inlet of the cyclone cooler through a pipeline; a feed outlet of the cyclone cooler is connected with a feed inlet of the low-valence vanadium oxide secondary cooling device through a pipeline; a gas outlet of the cyclone cooler s connected with a gas inlet of the second cyclone separator through a pipeline; and a feed outlet of the second cyclone separator is connected with a feed inlet of the low-valence vanadium oxide secondary cooling device through a pipeline;
a feed outlet of the low-valence vanadium oxide secondary cooling device s connected with a feed inlet of the low-valence vanadium oxide hopper through a pipeline; a cooling water inlet of the low-valence vanadium oxide secondary cooling device is connected with a process water main pipe through a pipeline; and a cooling water outlet of the low-valence vanadium oxide secondary cooling device is connected with a water cooling system through a pipeline;
a feed outlet at the bottom of the low-valence vanadium oxide hopper is connected with a feed inlet of the low-valence vanadium oxide screw feeder; and a feed outlet of the low-valence vanadium oxide screw feeder is connected with a feed inlet of the dissolution reactor through a pipeline;
a clean water inlet of the dissolution reactor s connected with a clean water main pipe through a pipeline; a concentrated sulfuric acid inlet of the dissolution reactor is connected with a concentrated sulfuric acid main pipe through a pipeline; a gas outlet of the dissolution reactor is connected with a gas inlet of the tail gas treatment system through a pipeline; and an electrolyte outlet of the dissolution reactor is connected with an electrolyte inlet of the electrolyte activation device through a pipeline.

2. The system for preparing a high-activity specific-valence electrolyte of an all-vanadium redox flow battery according to claim 1, wherein the reduction fluidized bed body is in the form of a rectangular multi-bin double outlet structure, and the fluidized bed has a built-in vertical baffle, each feed outlet is provided with a plug-in valve, and two feed outlets at high and low positions are respectively connected with the feed inlet of the reduction fluidized bed discharger through pipelines.

3. A method for preparing a high-activity specific-valence electrolyte of an all-vanadium redox flow battery based on the system of claim 1, comprising the following steps:
introducing vanadium-containing material from the vanadium-containing material hopper to enter the venturi preheater, the cyclone preheater and the first cyclone separator in turn through the vanadium-containing material screw feeder, and then enter the reduction fluidized bed body through the vanadium-containing material feeder; introducing the powder entrained in the high-temperature tail gas discharged from the reduction fluidized bed body to be collected by the reduction fluidized bed cyclone separator and then enter the feed inlet of the reduction fluidized bed discharger; making the reduced low-valence vanadium oxide be discharged from a feed outlet of the reduction fluidized bed body, and enter the venturi cooler and the cyclone cooler in turn through the reduction fluidized bed discharger, and enter the low-valence vanadium oxide secondary cooling device and the low-valence vanadium oxide hopper together with the powder material recovered by the second cyclone separator; introducing the material to enter the dissolution reactor through the low-valence vanadium oxide screw feeder, and be is subjected to dissolution reaction together with clean water from the clean water main pipe and concentrated sulfuric acid from the concentrated sulfuric acid main pipe to obtain a primary electrolyte; and introducing the primary electrolyte in the dissolution reactor to enter the electrolyte activation device through a pipeline with a valve, and be activated to obtain the high-activity specific-valence electrolyte of an all-vanadium redox flow battery;
wherein purified nitrogen gas enters the venturi cooler, the cyclone cooler and the second cyclone separator, and is mixed with the reducing gas purified by the reducing gas purifier and preheated by the reduction fluidized bed preheater, and then enters the reduction fluidized bed body, such that the vanadium-containing material powder is kept at a fluidized state and reduced; the high-temperature tail gas after reduction enters the reduction fluidized bed cyclone separator, the venturi preheater and the cyclone preheater, and finally is subjected to dust being removed by the first cyclone separator and then transmitted to the tail gas treatment system; and nitrogen gas from other two pipelines originating from the purified nitrogen gas main pipe enters the vanadium-containing material feeder and the reduction fluidized bed discharger, respectively;
wherein compressed air and fuel enter a compressed air inlet and the fuel inlet of the reduction fluidized bed preheater, respectively;
wherein process water from the process water main pipe flows into a water inlet of the low-valence vanadium oxide secondary cooling device and flows out of a water outlet of the low-valence vanadium oxide secondary cooling device, and then enters the water cooling system.

4. The method for preparing a high-activity specific-valence electrolyte of an all-vanadium redox flow battery according to claim 3, wherein the vanadium-containing material is one or more of vanadium pentoxide, ammonium metavanadate and ammonium polyvanadate.

5. The method for preparing a high-activity specific-valence electrolyte of an all-vanadium redox flow battery according to claim 3, wherein the reducing gas introduced into the reducing gas purifier is a mixture of one or two selected from hydrogen gas, ammonia gas, electric furnace gas, converter gas, blast furnace gas, coke oven gas and gas producer gas.

6. The method for preparing a high-activity specific-valence electrolyte of an all-vanadium redox flow battery according to claim 3, wherein by controlling the operation temperature, the average residence time of the powder, and the reducing atmosphere in the reduction fluidized bed, the average vanadium valence of the low-valence vanadium oxide in the reduction product can be any value in the range of 3.0-4.5;
wherein the operating temperature in the reduction fluidized bed is 400-700° C., in order to achieve this temperature, the corresponding temperature of the reduction fluidized bed preheater is controlled to be 450-950° C.;
the average residence time of the powder is 30-60 minutes, wherein when the average vanadium valence of the target low-valence vanadium oxide is 3.0-3.6, a feed outlet at a high position is used for discharging; and when the average vanadium valence of the target low-valence vanadium oxide is 3.6-4.5, a feed outlet at a low position is used for discharging;
the controlling and the reducing atmosphere has a volume fraction of the reducing gas in the mixed gas of nitrogen gas and the ratio of the reducing gas to the mixed gas of nitrogen is 10%-90%.

7. The method for preparing a high-activity specific-valence electrolyte of an all-vanadium redox flow battery according to claim 3, wherein in the high-activity specific-valence electrolyte of the all-vanadium redox flow battery prepared in the dissolution reactor, the average valence of vanadium ions is any value in the range of 3.0-4.5, the concentration of vanadium ions is in the range of 1.0-3.0 mol/L, and the concentration of sulfuric acid is in the range of 3.0-6.0 mol/L.

8. The method for preparing a high-activity specific-valence electrolyte of an all-vanadium redox flow battery according to claim 7, wherein when the average valence of vanadium ions in the electrolyte is 3.5, the electrolyte is directly used for a new all-vanadium redox flow battery stack.

9. The method for preparing a high-activity specific-valence electrolyte of an all-vanadium redox flow battery according to claim 3, wherein in the electrolyte activation device, the electrolyte is activated by applying microwave field externally with the activation time of 30-300 minutes, the activation temperature of 20-85° C., the microwave power density of 10-300 W/L, and the microwave frequency of 2450 MHz or 916 MHz.
